(19) United States
(12) Patent Application Publication
(10) Pub. No.: US 2024/0405843 A1
(43) Pub. Date: Dec. 5, 2024

(54) WIRELESS COMMUNICATION APPARATUS AND WIRELESS COMMUNICATION METHOD

(71) Applicant: NEC Corporation, Tokyo (JP)

(72) Inventor: Takuji MOCHIZUKI, Tokyo (JP)

(73) Assignee: NEC Corporation, Tokyo (JP)

(21) Appl. No.: 18/646,850

(22) Filed: Apr. 26, 2024

(30) Foreign Application Priority Data
May 29, 2023 (JP) 2023-087464

(51) Int. Cl. H04B 7/06; H04B 7/0413; H04L 5/14

(52) U.S. Cl. CPC H04B 7/0697; H04B 7/0413; H04L 5/14

(57) ABSTRACT

A wireless communication apparatus includes m transmitters (TXs), m receivers (RXs), a calibration transceiver (CAL-TRX), and a control unit that controls a UL CAL operation of transmitting a UL CAL signal from the CAL-TRX to each of the m RXs. The wireless communication apparatus performs a TDD operation. The control unit performs control in such a way as to perform the UL CAL operation in a predetermined time period before a downlink slot (DL slot) in which each of the m TXs transmits a downlink (DL) signal.

### INCORPORATION BY REFERENCE

This application is based upon and claims the benefit of priority from Japanese patent application No. 2023-087464, filed on May 29, 2023, the disclosure of which is incorporated herein in its entirety by reference.

### TECHNICAL FIELD

The present disclosure relates to a wireless communication apparatus and a wireless communication method.

### BACKGROUND ART

In fifth generation (5G) mobile communication, operation below 6 GHz (the Sub6 GHz band), which enables wide-area propagation and transmission suitable for mobile communication, has gained attention. Further, the traffic has continuously grown at an annual rate of 1.3 times, and there is also a need to respond to such a traffic demand. However, due to frequency constraints, it is not easy to secure a frequency bandwidth below 6 GHZ. In view of such circumstances, it is considered effective to use an active antenna system (AAS) adopting a full digital beamforming technique as a base station and apply spatial multiplexing and massive multi-input/multi-output (MIMO) through the AAS. Thus, commercialization of the AAS is underway both domestically and internationally. Further, in order to achieve a 5G system that supports Beyond5G/6G being expected to be introduced by 2030, it becomes increasingly necessary to deploy the AAS extensively.

With this situation, spatial multiplexing performance of the AAS is more crucial in the future. In the AAS, degradation of a signal-to-interference-plus-noise ratio (SINR) of a downlink (DL) signal at high output power is determined by emission of a non-linear distortion signal being emitted in the same direction as a desired wave signal to a desired terminal. Thus, in order to improve the above-mentioned non-linear distortion emission, the AAS is provided with a function of performing distortion compensation using digital pre-distortion (DPD) for DL signals transmitted from all transmitters within the AAS. In this manner, in the AAS, the spatial multiplexing performance in a high output region is significantly improved by simultaneously implementing improvement of non-linear distortion and full digital beamforming.

Further, in the AAS, in order to maintain and secure null depth in directions to other terminals other than a desired terminal (achieving spatial orthogonality), a DL calibration (CAL) operation for matching amplitude and phase characteristics among a plurality of transmitters within the AAS and an uplink (UL) CAL operation for matching amplitude and phase characteristics among a plurality of receivers within the AAS are performed. Specifically, a DL calibration weight (DL CAL weight) for compensating variation in amplitude and phase characteristics among the plurality of transmitters is calculated in the DL CAL operation, and an UL calibration weight (UL CAL weight) for compensating variation in amplitude and phase characteristics among the plurality of receivers is calculated in the UL CAL operation.

In the AAS, after improving the SINR of the DL signal by the DPD and at low output power setting, an influence of DL/UL CAL accuracy is dominant in determining the SINR of the DL signal. Thus, it is important to achieve a high SINR of the DL signal and achieve a large transmission capacity at a high cell throughput in the AAS by providing the AAS with double compensation of DL/UL CAL and DPD.

A configuration of an AAS 900 according to the related art and a DPD operation and DL/UL CAL operations in the AAS 900 according to the related art are described below.

First, with reference to FIG. 1, a circuit configuration example of the AAS 900 according to the related art is described. Note that, in FIG. 1, it is assumed that the AAS 900 is used as a base station. Further, in FIG. 1, description is made while assuming that the AAS 900 includes thirty-two antennas 41-1 to 41-32, which are described later, and the number of antennas included in the AAS 900 is not limited thereto and is only required to be plural.

As illustrated in FIG. 1, the AAS 900 according to the related art includes an optical transceiver 10, a baseband (BB) unit 20, a frontend unit 30, the thirty-two antennas 41-1 to 41-32, a calibration transceiver (CAL-TRX), a switch (SW) 52, and a calibration network (CAL network) 60.

Further, the BB unit 20 includes thirty-two DPD units 21-1 to 21-32 associated with the thirty-two antennas 41-1 to 41-32, respectively. Further, the FE unit 30 includes thirty-two transceivers (TRXs) 31-1 to 31-32, thirty-two transmission amplifiers 32-1 to 32-32, thirty-two reception amplifiers 33-1 to 33-32, thirty-two couplers 34-1 to 34-32, thirty-two SWs 35-1 to 35-32, and thirty-two band-pass filters (BPFs) 36-1 to 36-32 that are associated with the thirty-two antennas 41-1 to 41-32, respectively.

Note that, hereinafter, when description is made without distinguishing the antennas 41-1 to 41-32 from one another, the antennas are referred to as antennas 41-n (n=1, . . . , 32) as appropriate. Similarly, the DPD units 21-1 to 21-32, the TRXs 31-1 to 31-32, the transmission amplifiers 32-1 to 32-32, the reception amplifiers 33-1 to 33-32, the couplers 34-1 to 34-32, the SWs 35-1 to 35-32, and the BPFs 36-1 to 36-32 are referred to as DPD units 21-n, TRXs 31-n, transmission amplifiers 32-n, reception amplifiers 33-n, couplers 34-n, SWs 35-n, and BPFs 36-n as appropriate.

The optical transceiver 10 performs optical-to-electrical conversion and electrical-to-optical conversion of a signal that is transmitted and received between a distributed unit (DU) 200 and the BB unit 20.

When the DL CAL operation is performed, the BB unit 20 outputs a DL CAL signal to each of the TRXs 31-n in the FE unit 30. Further, when the UL CAL operation is performed, the BB unit 20 outputs an UL CAL signal to the CAL-TRX 51.

Further, when the DL operation is performed, the BB unit 20 outputs a DL signal being output from the optical transceiver 10 (for example, a beam foaming (BF) signal) to each of the TRXs 31-n in the FE unit 30. Further, when the UL operation is performed, the BB unit 20 outputs an UL signal being output from each of the TRXs 31-n in the FE unit 30 to the optical transceiver 10.

Further, as described above, the BB unit 20 includes the thirty-two DPD units 21-n. Signals pass through the transmission amplifiers 32-n, and are fed back from the couplers 34-n to the DPD units 21-n. The DPD units 21-n perform distortion compensation by the DPD for the signals (DL signals or DL CAL signals) passing through the transmission amplifiers 32-n by using the fed-back signals.

As described above, the FE unit 30 includes the thirty-two TRXs 31-n, the thirty-two transmission amplifiers 32-n, the thirty-two reception amplifiers 33-n, the thirty-two couplers 34-n, the thirty-two SWs 35-n, and the thirty-two BPFs 36-n.

The TRX 31-n includes a transmitter (TX) and a receiver (RX), which are omitted in illustration. Hereinafter, the TX in the TRX 31-n is referred to as a TX 311-n, and the RX in the TRX 31-n is referred to as an RX 312-n. The TX 311-n converts the signal being output from the BB unit 20 (the DL signal or the DL CAL signal) from an in-phase and quadrature (IQ) signal to a radio frequency (RF) signal, and outputs the converted signal to the transmission amplifier 32-n. Further, the RX 312-n converts the signal being output from the reception amplifier 33-n (the UL signal or the UL CAL signal) from an RF signal to an IQ signal, and outputs the converted signal to the BB unit 20.

The transmission amplifier 32-n amplifies the signal being output from the TX 311-n in the TRX 31-n (the DL signal or the DL CAL signal), and outputs the amplified signal to the SW 35-n.

The coupler 34-n feeds back the signal passing through the transmission amplifier 32-n to the DPD unit 21-n via the RX 312-n in the TRX 31-n.

The reception amplifier 33-n amplifies the signal being output from the SW 35-n (the UL signal or the UL CAL signal, and outputs to the RX 312-n in the TRX 31-n.

The SW 35-n is a switch that switches connection between the TRX 31-n, and the antenna 41-n and the CAL network 60. When the DL CAL operation is performed, the SW 35-n outputs the DL CAL signal being output from the transmission amplifier 32-n to the CAL network 60. Further, when the UL CAL operation is performed, the SW 35-n outputs the UL CAL signal being output from the CAL network 60 to the reception amplifier 33-n. Further, when the DL operation is performed, the SW 35-n outputs the DL signal being output from the transmission amplifier 32-n to the antenna 41-n. Further, when the UL operation is performed, the SW 35-n outputs the UL signal being output from the antenna 41-n to the reception amplifier 33-n.

Among signals being transmitted and received between the TRX 31-n, and the antenna 41-n and the CAL network 60, the BPF 36-n only causes a signal in a predetermined frequency band to pass therethrough.

When the DL CAL operation is performed, the CAL network 60 combines the DL CAL signal being output from each of the SWs 35-n, and outputs the combined signal to the SW 52. Further, when the UL CAL operation is performed, the CAL network 60 divides the UL CAL signal being output from the SW 52, and outputs the divided signal to each of the SWs 35-n.

The SW 52 is a switch that switches connection between the CAL-TRX 51 and the CAL network 60. When the DL CAL operation is performed, the SW 52 outputs the DL CAL signal being output from the CAL network 60 to the CAL-TRX 51. Further, when the UL CAL operation is performed, the SW 52 outputs the UL CAL signal being output from the CAL-TRX 51 to the CAL network 60.

The CAL-TRX 51 includes a calibration transmitter (CAL-TX) and a calibration receiver (CAL-RX), which are omitted in illustration. Hereinafter, the CAL-TX in the CAL-TRX 51 is referred to as a CAL-TX 511, and the CAL-RX in the CAL-TRX 51 is referred to as a CAL-RX 512. When the DL CAL operation is performed, the CAL-RX 512 converts the DL CAL signal being output from the SW 52 from an RF signal to an IQ signal, and outputs the converted signal to the BB unit 20. Further, when the UL CAL operation is performed, the CAL-TX 511 converts the UL CAL signal being output from the BB unit 20 from an IQ signal to an RF signal, and outputs the converted signal to the SW 52.

When the DL CAL operation is performed, the BB unit 20 calculates a DL CAL weight of each of the TXs 311-n, based on the DL CAL signal being output from the CAL-RX 512. Further, when the UL CAL operation is performed, the BB unit 20 calculates a UL CAL weight of each of the RXs 312-n, based on the UL CAL signal being output from each of the RXs 312-n.

When the DL operation is performed, the antennas 41-n transmits the DL signal being output from the SW 35-n to user equipment (UE), which is omitted in illustration. Further, when the UL operation is performed, the antenna 41 receives the UL signal from the UE, and outputs the received signal to the SW 35-n.

A schematic operation of the AAS 900 according to the related art is described below.

First, with reference to FIG. 2, operation examples of the DL CAL operation and the DPD operation of the AAS 900 according to the related art are described.

As illustrated in FIG. 2, the BB unit 20 outputs the DL CAL signal to each of the TXs 311-n in each of the TRXs 31-n. Each of the TXs 311-n converts the DL CAL signal from an IQ signal to an RF signal, and outputs the converted signal. The DL CAL signal being output from each of the TXs 311-n is amplified at each of the transmission amplifiers 32-n, and then is output to the CAL network 60. In this state, each of the couplers 34-n feeds back the DL CAL signal passing through the transmission amplifier 32-n to the DPD unit 21-n in the BB unit 20. Each of the DPD units 21-n performs distortion compensation by the DPD for the DL CAL signal passing through the transmission amplifier 32-n thereafter by using the fed-back signal. Further, the DL CAL signal being output to the CAL network 60 is a signal acquired by allocating the DL CAL signals being output from the plurality of TXs 311-n in a frequency multiplexing manner. With this, the frequencies of the DL CAL signals being output from the TXs 311-n are determined in advance in such a way that the frequencies do not overlap with each other even when the DL CAL signals are combined in the CAL network 60. In other words, the frequency allocation of each sub carrier forming the DL CAL signal by OFDM is determined in advance in such a way as to avoid overlapping at each of the TXs 311-n. A method of transmitting the DL CAL signals from all the TXs 311-n to the CAL-RX 512 in one DL CAL period is a first DL CAL signal allocation/transmission method. Another transmission method involves performing transmission and reception of the DL CAL signal for each frame at one TX 311-n at a time. In other words, a method of sequentially time-division multiplexing DL CAL signals with frequency overlaps or DL CAL signals with completely common frequency allocations from each of the TXs 311-n and sequentially transmitting/receiving the DL CAL signals while switching the TX 311-n being a DL CAL target is a second DL CAL signal allocation/transmission method. Thus, in a case of the second DL CAL signal allocation/transmission method being the latter method, the DL CAL signal passing through the CAL network 60 is for one TX 311-n, and hence DL CAL transmission/reception is repeated the same number of times as the number of TXs 311-n. However, in any one of the above-mentioned two DL CAL signal allocation/transmission methods, the signal passes through the CAL network 60 from each of the TXs 311-n, and then is transmitted to the CAL-RX 512 in the CAL-TRX 51 via the SW 52. The CAL-RX 512 converts the DL CAL signal being transmitted from the CAL network 60 from an RF signal to an IQ signal, and outputs the converted signal to the BB unit 20.

In a case of the above-mentioned first DL CAL signal allocation/transmission method being the former method, the method involves frequency multiplexing where the DL CAL signals between the TXs 311-n are multiplexed in uncorrelated and orthogonal frequency allocations. In this case, after passing through the CAL network 60, the DL CAL signal being output from each of the TXs 311-n in each of the TRXs 31-n is in a frequency-multiplexed and combined state at the CAL-RX 512. Thus, as in a case of the first DL CAL signal allocation/transmission method, when the DL CAL signal is frequency-multiplexed, and the DL CAL signal is simultaneously and collectively received at the CAL-RX 512, the BB unit 20 divides an extracts the DL CAL signal being output from the CAL-RX 512 again into the DL CAL signal for each of the TXs 311-n, and then calculates a DL CAL weight. However, in a case of the above-mentioned second DL CAL signal allocation/transmission method, transmission/reception of the DL CAL signal for each frame is performed at one TX 311-n at a time. In other words, DL CAL signals with frequency overlaps or DL CAL signals with completely common frequency allocations from each of the TXs 311-n are time-division multiplexed sequentially, and the DL CAL signals are sequentially received at the CAL-RX 512 for a plurality of times while switching the TX 311-n being a DL CAL target. In a case of the second DL CAL signal allocation/transmission method, the DL CAL weight is individually calculated for each of the TXs 311-n by using the DL CAL signal that is output from each of the TXs 311-n and passes through the CAL network 60. In other words, in a case of the second DL CAL signal allocation/transmission method, the DL CAL weight is sequentially calculated for each of the TXs 311-n for a plurality of times over time.

Herein, as expressed in Equation 1 given below, the DL CAL weight of the TX 311-n is acquired by multiplying the amplitude and phase characteristics [TX #n] of the TX 311-n and the amplitude and phase characteristics [CAR-RX] of the CAL-RX 512.

$$DL CAL WEIGHT = [ TX \# n ] \times [ C A L - R X ] \qquad [ Equation 1 ]$$

Subsequently, with reference to FIG. 3, description is made on operation examples of the DL operation and the DPD operation of the AAS 900 according to the related art.

As illustrated in FIG. 3, the BF signal being transmitted from the DU 200 is input to the BB unit 20 via the optical transceiver 10. The BB unit 20 corrects the BF signal by using the DL CAL weight of each of the TXs 311-n in each of the TRXs 31. Specifically, the BB unit 20 multiplies the BF signal by a fraction with the DL CAL weight as the denominator and the fixed amplitude and phase characteristics of the CAL-RX 512 [CAL-RX (FIXED)] as the numerator. The BF signal after correction is expressed in Equation 2 given below. Note that [CAL-RX (FIXED)] is a value acquired by measurement for each AAS during a testing process in the factory production, or is a fixed value determined in the design specification. [CAL-RX (FIXED)] is stored in advance in the BB unit 20.

$$\frac{B F \times [ CAL - RX ( FIXED ) ]}{[ TX \# n ] \times [ C A L - R X ]} \qquad [ Equation 2 ]$$

The BF signal after correction by the BB unit 20 is converted from an IQ signal to an RF signal at each of the TXs 311-n and amplified at each of the transmission amplifiers 32-n, and then is output from the FE unit 30 to each of the antennas 41-n. In this state, each of the couplers 34-n feeds back the BF signal passing through the transmission amplifier 32-n to the DPD unit 21-n in the BB unit 20. Each of the DPD units 21-n performs distortion compensation by the DPD for the BF signal passing through the transmission amplifier 32-n thereafter by using the fed-back signal. However, at the time of operating the DPD and the DL CAL in a co-existing manner according to the non-linearity characteristics of the AMP, when the linearity characteristics at low input/output power is secured in the AMP, the level of the DL CAL signal is set in advance to a DPD On threshold value. With this, while detecting a transmission signal containing a DL CAL signal below the DPD On threshold value, the non-linearity characteristics at high input/output power is compensated, and compensation is performed in a low input/output power region with the satisfactory linearity characteristics for aligning the variation of the amplitude-phase-frequency characteristics of the TXs 311-n by the DL CAL. However, the non-linearity degree of the AMP in the low input/output power region also indicates the AM-AM and AM-PM characteristics different from those in the high input/output power region. Thus, in a case of the poor linearity characteristics, linearization is first performed by the DPD across a wide dynamic range of the AMP from the low input/output power region to the high input/output power region, and then the DL CAL compensation is performed after the linearization by the DPD in the entire input/output region in some cases.

Herein, the BF signal being output from the FE unit 30 to each of the antennas 41-n passes through each of the TXs 311-n, and is expressed in Equation 3 given below.

$$\frac{B F \times [ C A L - RX ( FIXED ) ]}{[ TX \# n ] \times [ C A L - R X ]} \times [ TX \# n ] \qquad [ Equation 3 ]$$

Further, when [TX #n] is removed, Equation 3 is expressed in Equation 4 given below.

$$\frac{B F \times [ C A L - RX ( FIXED ) ]}{[ C A L - R X ]} \qquad [ Equation 4 ]$$

In Equation 4, when [CAL-RX (FIXED)]=[CAR-RX] is satisfied, the BF signal is in an ideal state, and the BF signal in the ideal state is transmitted from each of the antennas 41-n to the UE.

Subsequently, with reference to FIG. 4, description is made on an operation example of the UL CAL operation of the AAS 900 according to the related art.

As illustrated in FIG. 4, the BB unit 20 outputs the UL CAL signal to the CAL-TX 511 in the CAL-TRX 51. The CAL-TX 511 converts the UL CAL signal from an IQ signal to an RF signal, and outputs the converted signal. The UL CAL signal being output from the CAL-TX 511 is distributed to each of the RXs 312-n via the CAL network 60.

The UL CAL signal being distributed via the CAL network 60 is amplified at each of the reception amplifiers 33-n, is converted from an RF signal to an IQ signal at each of the RXs 312-n in each of the TRXs 31, and then is output from the FE unit 30 to the BB unit 20.

The BB unit 20 calculates a UL CAL weight for each of the RXs 312-n, based on the UL CAL signal being output from each of the RXs 312-n. Note that, unlike the DL CAL signal, even in a case of the same UL CAL signal, the UL CAL weight can be calculated for each of the RXs 312-n after the UL CAL signal is distributed to each of the RXs 312-n via the CAL network 60. Thus, for the UL CAL, the UL CAL weights of all the RXs 312-n can be acquired in one step by using the same UL CAL signal for each of the RXs 312-n.

Herein, as expressed in Equation 5 given below, the UL CAL weight of the RX 312-n is acquired by multiplying the amplitude and phase characteristics [RX #n] of the RX 312-n and the amplitude and phase characteristics [CAL-TX] of the CAL-TX 511.

$$UL CAL WEIGHT = [ RX \# n ] \times [ CAL - TX ] \qquad [ Equation 5 ]$$

Subsequently, with reference to FIG. 5, description is made on an operation example of the UL operation of the AAS 900 according to the related art.

As illustrated in FIG. 5, each of the antennas 41-n receives and outputs the UL signal being a UL Ch estimation wave. The UL signal being output from each of the antennas 41-n is amplified at each of the reception amplifiers 33-n, is converted from an RF signal to an IQ signal at each of the RXs 312-n in each of the TRXs 31, and then is output from the FE unit 30 to the BB unit 20. The UL signal being output from the FE unit 30 passes through each of the RXs 312-n, and hence is expressed in Equation 6 given below.

$$UL \times [ RX \# n ] \qquad [ Equation 6 ]$$

The BB unit 20 corrects the UL signal by using the UL CAL weight of each of the RXs 312-n. Specifically, the BB unit 20 multiplies the UL signal by a fraction with the UL CAL weight as the denominator and the fixed amplitude and phase characteristics of the CAL-TX 511 [CAL-TX (FIXED)] as the numerator. The UL signal after correction is expressed in Equation 7 given below. Note that, as [CAL-TX (FIXED)], a value acquired by measurement for each AAS during a testing process in the factory production or is a fixed value determined in the design specification is stored in advance in the BB unit 20.

$$\frac{U L \times [ C A L - TX ( FIXED ) ]}{[ RX \# n ] \times [ C A L - T X ]} \times [ RX \# n ] \qquad [ Equation 7 ]$$

Further, when [RX #n] is removed, Equation 7 is expressed in Equation 8 given below.

$$\frac{U L \times [ C A L - TX ( FIXED ) ]}{[ CAL - TX ]} \qquad [ Equation 8 ]$$

In Equation 8, when [CAL-TX (FIXED)]=[CAL-TX] is satisfied, the UL signal is in an ideal state, and the UL signal in the ideal state is output from the BB unit 20 to the DU 200.

Subsequently, with reference to FIG. 6, description is made on a timing at which the AAS 900 according to the related art performs the DL CAL operation and the UL CAL operation.

In FIG. 6, it is assumed that the AAS 900 according to the related art performs a time division duplex (TDD) operation. The TDD operation is an operation of performing transmission and reception by switching between the DL operation and the UL operation over time by using the same frequency for the UL and the DL. The DL operation is performed in a DL slot, and the UL operation is performed in a UL slot. A section in which switching is performed from the DL slot to the UL slot is provided with a flexible slot. The flexible slot includes a downlink pilot time slot (DwPTS), a guard period (GP), and an uplink pilot time slot (UpPTS). The DwPTS is a section reserved for the DL operation. The UpPTS is a section reserved for the UL operation. The GP is a section in which the DL operation and the UL operation are not performed.

Further, FIG. 6 illustrates a DL timing of the AAS 900, an on/off state of the TX 311-n of the AAS 900, a UL timing of the AAS 900, and an on/off state of the RX 312-n of the AAS 900 in the order from the top with regard to the AAS 900. Moreover, FIG. 6 illustrates a DL timing of the UE, an on/off state of a receiver (RX) of the UE, a UL timing of the UE, and an on/off state of a transmitter (TX) of the UE in the order from the top with regard to the UE that communicates with the AAS 900.

As illustrated in FIG. 6, in some cases, the AAS 900 according to the related art performs the CAL according to a DL/UL CAL sequence specification in which the DL CAL operation (in other words, an operation of transmitting the DL CAL signal from each of the TXs 311-n to the CAL-RX 512) is performed and then the UL CAL operation (in other words, an operation of transmitting the UL CAL signal from the CAL-TX 511 to each of the RXs 312-n) is performed within a time period of the GP in the flexible slot after the DL slot and a time period being a Tx off transient period (10 usec in the 3-rd generation partnership project (3GPP) (registered trademark) standard for 5G), which is a time period for switching the TX 311-n from an on state to an off state. Alternatively, in a repetition cycle of each of the DL/UL configurations (in one example, when the sub carrier spacing is 30 kHz, “DDDFU” where D indicates the DL slot, F indicates the flexible slot, and U indicates the UL slot is repeatedly TDD-operated every 2.5 msec per frame), the DL CAL signal allocation between the TXs 311-n is frequency-multiplexed allocation for each frame determined by the TDD DL/UL configuration (for example, a cycle of 2.5 msec per five slots in European Region 1 described above or a cycle of 5 msec per ten slots in a case of European Region 2). In the case of European Region 1, the repetition period is 2.5 milliseconds (ms) per frame with a 5-slot period. Alternatively, in the case of European Region 2, the repetition period is 5 milliseconds (ms) per frame with a 10-slot period. Alternatively, a common DL CAL signal or a DL CAL signal with frequency overlaps is sequentially transmitted for each of the TXs 311-n. In both of the cases, there may be adopted a CAL specification in which, throughout the entire duration of the Tx off transient period of 10 usec, a frame for performing the DL CAL while allocating only the DL CAL signal and a frame for performing the UL CAL while allocating only the UL CAL signal are alternatingly allocated (as described above, for the UL CAL, the completely common UL CAL signal is transmitted and received collectively by all the RXs 312-n). Note that, in some cases, the UL CAL operation is performed by exceeding the Tx off transient period up to the GP or beyond. However, in this case, the TX off power limit specified in the 3GPP is required to be equal to or less than-83 dBm/MHz. Thus, the level of the UL CAL signal passing through the end of antenna 41-n is significantly attenuated to conduct the UL CAL, but the level of the UL CAL signal passing through the end of antenna 41-n is required to comply with the TX off power limit of −83 dBm/MHz or below. In this case, the SINR of the UL SINR is reduced, and hence averaging processing is also performed to improve the SINR after reception of the UL CAL to a desired value in such a way as to secure a desired UL CAL SINR. When the averaging count=N is satisfied, the averaging processing is performed for 20 Log(N)−10 Log(N)=10 Log(N) times.

Note that examples of the technique of performing the DL CAL operation and then performing the UL CAL operation within the time period of GP in the flexible slot include the technique described in Japanese Unexamined Patent Application Publication No. 2019-216366.

As described above, in an example embodiment, the AAS 900 according to the related art performs the DL CAL operation, and then performs the UL CAL operation in the time period being the Tx off transient period of the GP in the flexible slot after the DL slot. A problem of the operation is described below.

For example, it is assumed that a plurality of AASs are present far away (several kilometers away) from the AAS 900, the plurality of AASs performing a TDD operation in a frequency band, which is different from the frequency band of the AAS 900 but is encompassed within the passband of the BPF 36-n of the AAS 900, and being operated by different operators are present far away (several kilometers away) from the AAS 900.

In this case, DL delay emission signals according to separation distances (delay of several tens of microseconds) arrives at the AAS 900 from the plurality of AASs of the other operators. Thus, the DL delay emission signals interfere with the DL CAL signal and the UL CAL signal that are transmitted and received by the AAS 900 in the time period being the Tx off transient period.

For example, in the upper example of FIG. 7, an AAS of an operator A transmits and receives a DL CAL signal and a UL CAL signal in a frequency band a in a time period being a Tx off transient period. However, a frequency band b of an AAS of an operator B and a frequency band c of an AAS of an operator C are adjacent to the frequency band a, and are encompassed within a passband of an RF BPF of the AAS of the operator A. In particular, when the AAS of the operator A performs radio access network (RAN) sharing with the operators B and C, the passband of the RF BPF is required to cover the frequency bands of all the operators. Thus, the RF BPF specification itself does not allow suppression of transmission waves from operators other than operator A. Thus, over time, the DL delay emission signals from the AASs of the operators B and C interfere with the DL CAL signal and the UL CAL signal that are transmitted and received by the AAS of the operator A.

Further, in the lower example of FIG. 7, an AAS of an operator D transmits and receives a DL CAL signal and a UL CAL signal in a frequency band in a time period being a Tx off transient period. However, a frequency band e of an AAS of an operator E is encompassed in a passband of an RF BPF of the AAS of the operator D. Thus, over time, the DL delay emission signal from the AAS of the operator E interferes with the DL CAL signal and the UL CAL signal that are transmitted and received by the AAS of the operator D.

However, when the DL CAL signal is transmitted from each of the TXs 311-n to the CAL-RX 512, the level thereof can be amplified by the transmission amplifier 32-n to a maximum rated power level equivalent to an operational DL transmission wave within 10 usec during the TX off transient term, as long as compliance with the spurious standards set by the 3GPP and local radio regulations is ensured. In this manner, when the DL CAL signal is transmitted in a high-level and high-SINR state, the DL CAL signal is not affected by interference from the DL delay emission signal.

Meanwhile, the UL CAL signal is transmitted from the CAL-TX 511, but the level thereof cannot be amplified because the transmission does not involve an amplifier. Further, when the UL CAL operation is performed by exceeding the Tx off transient period up to the GP or beyond, each of the TXs 311-n is required to comply with the TX off power limit (−83 dBm/MHz) or below, and hence it is required to prevent unnecessary emission from the antenna 41-n. Further, when a transmission AMP is inserted, the UL CAL level can be amplified to a level equivalent to the DL CAL level. However, non-linear distortion is caused to the UL CAL signal due to the insertion of the transmission AMP. Thus, with regard to the reception level of the UL CAL signal that is transmitted from the CAL-TX 511 to each of the RXs 312-n and is received at the input end of each of the reception amplifiers 33-n, the non-linear distortion thereof is required to be improved by the DPD. Thus, for performing the UL CAL, an unintended transmission AMP and DPD are required, and the disadvantageous influence of the remaining non-linear distortion of AM-AM/AM-PM on the UL CAL accuracy cannot be ignored even when the non-linear distortion is compensated by the DPD. Thus, the transmission AMP and the DPD are not provided, and the UL CAL level is attenuated with power distribution of approximately −3 dB at each branch of the UL CAL signal in the CAL network 60 at 1:n. Thus, the level of the UL CAL signal being input to each of the RXs 312-n is extremely attenuated. Further, due to the disparity in the wiring length of the CAL network 60, which serves as the passage for the UL CAL signal from the CAL-TX 511 to each of the RXs 312-n, there may also be variations in the level of the UL CAL signal received by each of the RXs 312-n. Thus, the AAS 900 also performs the averaging processing to improve the SINR of the received UL CAL signal to a desired value by increasing the number N of repetitions for repeating the UL CAL operation, thereby securing a desired UL CAL SINR. When the averaging count=N is satisfied, the averaging processing is performed for 20 Log(N)−10 Log(N)=10 Log(N) times.

Further, when a frequency band of an AAS of another operator is encompassed within the passband of the BPF 36-n of the AAS 900, the DL delay emission signal from the AAS of the other operator or an antenna separation-type base station is also received at the input end of each of the reception amplifiers 33-n via the antenna 41-n, the BPF 36-n, and the SW 35-n. In this state, the reception level of the DL delay emission signal exceeds the reception level of the UL CAL signal at the input end of each of the reception amplifiers 33-n, and hence the UL CAL signal possibly experiences significant interference from the DL delay emission signal. In this state, in a post-reception system circuit including the reception amplifier 33-n, reception system saturation occurs due to delayed interference from the DL delay emission signal in some cases. Reception saturation in the post-reception system circuit including the reception amplifier 33-n causes reception clipping distortion, a frequency spectrum splash component due to the reception clipping distortion suddenly spreads across the frequency band being used by the AAS 900 for transmission and reception in the TDD operation, and thus causes destructive interference.

With reference to FIG. 8, description is made on an example in which a frequency spectrum splash is generated due to a DL delay emission signal. (a) and (b) of FIG. 8 indicate characteristics of reception power at the input end of the reception amplifier 33-n, where the horizontal axis indicates time and the vertical axis indicates a power level of the reception power. Note that, during the test, the transmission and reception operations of the AAS being a test target are set only to continuous reception for all slots in an outdoor environment. Further, in the setting, the focus is on Symbol #9 (the final tenth DL Symbol because the symbol number is zero-indexed) being the final DL symbol in the final DL slot within the frame (the DwPTS: DL 10 symbols, the GP: 2 symbols, the UpPTS: 2 symbols within the flexible slot located between DL and UL in the TDD DL/UL configuration of “DDDFU”) and Symbol #10 being the first symbol of the GP 2 symbols including the subsequent TX off transient period of 10 μsec. Thus, in (a) and (b) of FIG. 8, for Symbol #9 and Symbol #10 including the TX off transient period of 10 μsec, the horizontal axis indicating time and the vertical axis indicating a reception level are surrounded by the bold squares in a highlighted manner for easy understanding.

As indicated with the arrow Z, the DL signal accompanied with the delay (occurring according to a separation distance from the own AAS) from the band of the other operator B of FIG. 8 in (b) of FIG. 8 interferes with the UL CAL signal section in the band of the operator A of FIG. 7 in (a) of FIG. 8, and exceeds the AAS reception saturation level. With this, the AAS reception saturation occurs, and a spectrum splash accompanied with frequency diffusion due to hard clipping distortion is generated. With this, as illustrated in (c) and (d) of FIG. 8, splash interference occurs to the UL CAL signal in the band of the operator A, which is adjacent to the band of the operator C, and the SINR of the DL CAL signal is significantly degraded. With this degradation, the amplitude and phase variation between the RXs due to deficient UL CAL is increased, and hence a CAL alarm is issued. When the number of CAL alarms exceeds the specified number, deficient beamforming is caused, and thus the AAS is caused to stop operating.

Further, as described above, Symbol #9 indicates the final DL symbol within the final DL slot of the DwPTS in the flexible slot located between DL and UL. Further, Symbol #10 indicates a symbol being the leading symbol in the subsequent GP and including the Tx off transient period in which the UL CAL operation is performed. Note that, in (a) and (b) of FIG. 8, it is also assumed that a DL delay wave from an adjacent operator base station does not exceed the reception saturation root mean square (RMS) level in the TX off transient period of 10 μsec in which the UL CAL is performed by receiving the UL CAL signal. Further, it is assumed that, in the TX off transient period of 10 μsec, no splash spreading occurs in the frequency spectrum of the DL delay wave from the adjacent operator base station with an adjacent frequency band due to hard clipping caused by complete reception saturation. Even in such a case, in the adjacent operator base station, the reception system is in a non-linear state due to the DL delay wave level, and an adjacent channel leakage ratio (ACLR) of the DL delay wave (adjacent leakage power distortion) is caused. Thus, due to an influence of the ACLR of the DL delay wave from the adjacent operator base station, SINR degradation is caused in the UL CAL signal. Thus, it is noted that, even in a deficient saturation state, degradation due to the non-linear distortion occurs during reception of the UL CAL signal. Note that, among the time signals of both the operator bands in (a) and (b) of FIG. 8, (c) of FIG. 8 is acquired by subjecting Symbol #9 being the leading symbol before the TX off transient period of 10 μsec to a fast Fourier transform (FFT) analysis and converting a time domain into a frequency domain, where the horizontal axis indicates a frequency and the vertical axis indicates a power level of own reception. However, in (c) of FIG. 8, the DL wave from the adjacent operator base station always exceeds the reception saturation RMS level. Thus, although the UL CAL signal is not present in Symbol #9, it is understood that reception is completely saturated in this state by the DL wave from the adjacent operator base station with an adjacent frequency band. Further, in Symbol #9, it is understood that the frequency spectrum of the DL wave from the adjacent operator base station interferes in a spreading manner across the wide frequency range to cover the reception band. Further, Symbol #10 subsequent thereto is a symbol in which the UL CAL signal is present, and is the leading symbol of the two symbols in the GP including the TX off transient period of 10 μsec in which the UL CAL is performed. (d) of FIG. 8 is acquired by subjecting Symbol #10 in (a) and (b) of FIG. 8 to FFT. In (d) of FIG. 8, in the leading part of Symbol #10 in the TX off transient period of 10 μsec, the reception is continuously at or above the complete saturation level due to the DL delay wave from the adjacent operator base station. Thus, in a case of (d) of FIG. 8, in the entirety of Symbol #10, the reception is completely saturated by the DL delay wave from the adjacent operator base station and the frequency splash interference level is averaged, and thus it seems that the interference level is lowered as compared to that of the band of the operator A in (c) of FIG. 8. However, as indicated in (c) of FIG. 8, in the TX off transient period of 10 μsec in the leading part of Symbol #10 in which the UL CAL signal is present, the frequency spectrum of the UL CAL signal is affected by complete saturation due to the DL delay wave from the adjacent operator base station and is masked with the frequency splash interference level, and the SINR thereof is negative. Thus, in this interference state, the UL CAL is fully deficient, and the TRX is stopped by issuing a UL CAL alarm. Moreover, in this interference state, it is conceived that the allocation and the separation distance between the base station and the adjacent operator base station are not changed. Thus, the UL CAL alarm is frequently issued as the operation continues, and more TRXs are stopped, which eventually escalates to the worst-case scenario where all the TRXs are stopped.

Note that, during the operation, the AAS 900 grasps amplitude and phase deviation of each of the RXs 312-n from the average amplitude and phase of all the RXs 312-n by transmitting and receiving the UL CAL signal. The AAS 900 determines the RX 312-n with abnormal amplitude and phase deviation as UL CAL deficiency, and issues a UL CAL alarm. Thus, when significant splash interference exceeding the reception level of the UL CAL signal occurs, and UL CAL alarms are sequentially issued to the TRXs 31-n, the AAS 900 determines that the TRXs 31-n have operation abnormality and stops the TRXs 31-n. In this manner, when the TRXs 31-n are stopped one after another, the operation of the AAS 900 cannot be continued, and there arises a problem that the operation of the AAS 900 is eventually stopped.

### SUMMARY

In view of this situation, an example object of the present disclosure is to provide a wireless communication apparatus and a wireless communication method that can solve the above-mentioned problems and can perform an uplink calibration operation regardless of arrival of a delay emission signal from another wireless communication apparatus.

In a first example aspect of the present disclosure, a wireless communication apparatus includes:
a plurality of transmitters;
a plurality of receivers;
a calibration transceiver; and
a controller configured to control an uplink calibration operation of transmitting an uplink calibration signal from the calibration transceiver to each of the plurality of receivers, wherein
the wireless communication apparatus performs a time division duplex (TDD) operation, and
the controller performs control in such a way as to perform the uplink calibration operation in a predetermined time period before a downlink slot in which each of the plurality of transmitters transmits a downlink signal.

In a second example aspect of the present disclosure, a wireless communication method is performed by a wireless communication apparatus including a plurality of transmitters, a plurality of receivers, and a calibration transceiver, and being configured to perform a time division duplex (TDD) operation, the wireless communication method including:
a control step of controlling an uplink calibration operation of transmitting an uplink calibration signal from the calibration transceiver to each of the plurality of receivers, wherein,
in the control step, control is performed in such a way as to perform the uplink calibration operation in a predetermined time period before a downlink slot in which each of the plurality of transmitters transmits a downlink signal.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a circuit diagram illustrating a circuit configuration example of an AAS according to a related art;

FIG. 2 is a diagram for describing operation examples of a DL CAL operation and a DPD operation of the AAS according to the related art;

FIG. 3 is a diagram for describing operation examples a DL operation and the DPD operation of the AAS according to the related art;

FIG. 4 is a diagram for describing an operation example of an UL CAL operation of the AAS according to the related art;

FIG. 5 is a diagram for describing an operation example of an UL operation of the AAS according to the related art;

FIG. 6 is a diagram for describing an example of a timing at which the AAS according to the related art performs the DL CAL operation and the UL CAL operation;

FIG. 7 is a diagram for describing an example in which the AAS according to the related art experiences interference from a DL delay emission signal form an AAS of another operator;

FIG. 8 is a diagram for describing an example in which, in the AAS according to the related art, a frequency spectrum splash is generated due to the DL delay emission signal from the AAS of the other operator;

FIG. 9 is a circuit diagram illustrating a circuit configuration example of an AAS according to a first example embodiment;

FIG. 10 is a diagram for describing an example of a timing at which the AAS according to the first example embodiment performs a DL CAL operation and a UL CAL operation;

FIG. 11 is a diagram for describing an example of a timing at which the AAS according to the first example embodiment performs the DL CAL operation and the UL CAL operation and comparing the example with an example of a timing at which the AAS according to the related art performs the DL CAL operation and the UL CAL operation;

FIG. 12 is a diagram for describing an example of a control method of a reception system circuit in an FE unit when an AAS described in Japanese Unexamined Patent Application Publication No. 2019-216366 performs a DL operation;

FIG. 13 is a diagram for describing an example of a control method of the reception system circuit in the FE unit when the AAS described in Japanese Unexamined Patent Application Publication No. 2019-216366 performs a UL CAL operation;

FIG. 14 is a diagram for describing an example of a control method of the reception system circuit in the FE unit when the AAS described in Japanese Unexamined Patent Application Publication No. 2019-216366 performs a UL operation;

FIG. 15 is a circuit diagram illustrating a circuit configuration example when an injection point of a UL CAL signal and a DL CAL signal is allocated in a commonly shared manner between an antenna and a BPF in the AAS according to the first example embodiment;

FIG. 16 is a circuit diagram illustrating a circuit configuration example of a wireless communication apparatus according to a second example embodiment; and

FIG. 17 is a block diagram illustrating a hardware configuration example of a computer that achieves some of functions of the wireless communication apparatus according to the present disclosure.

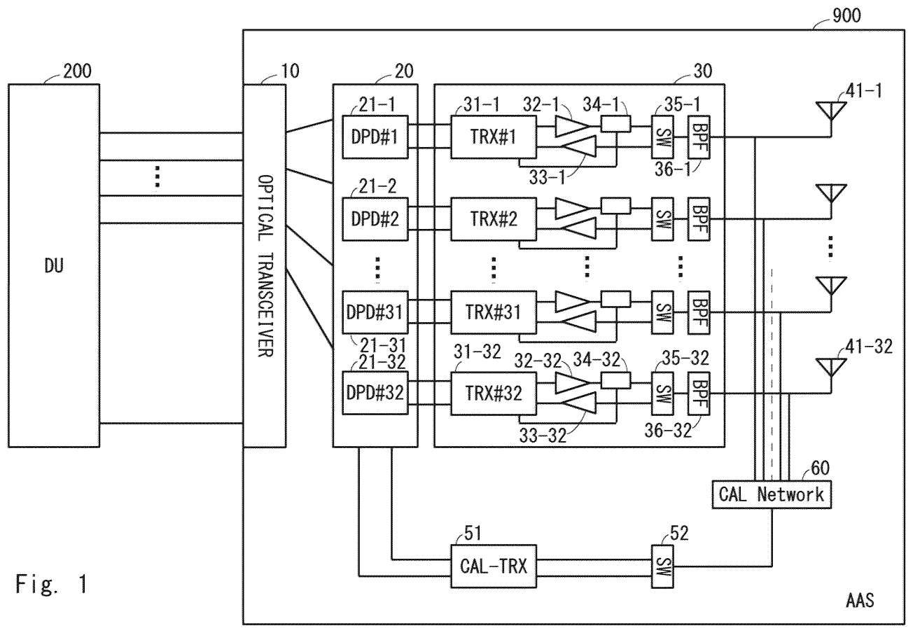

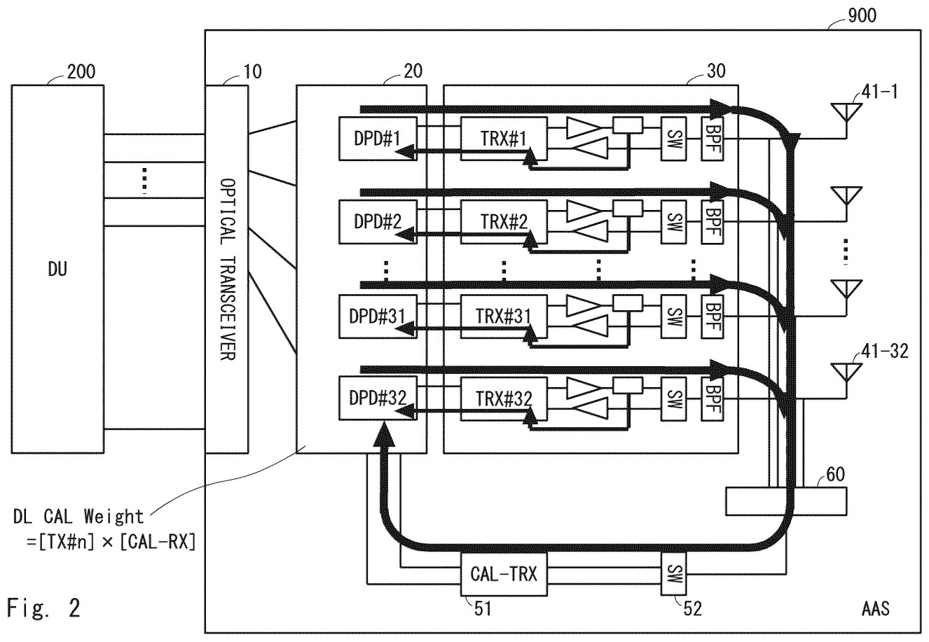

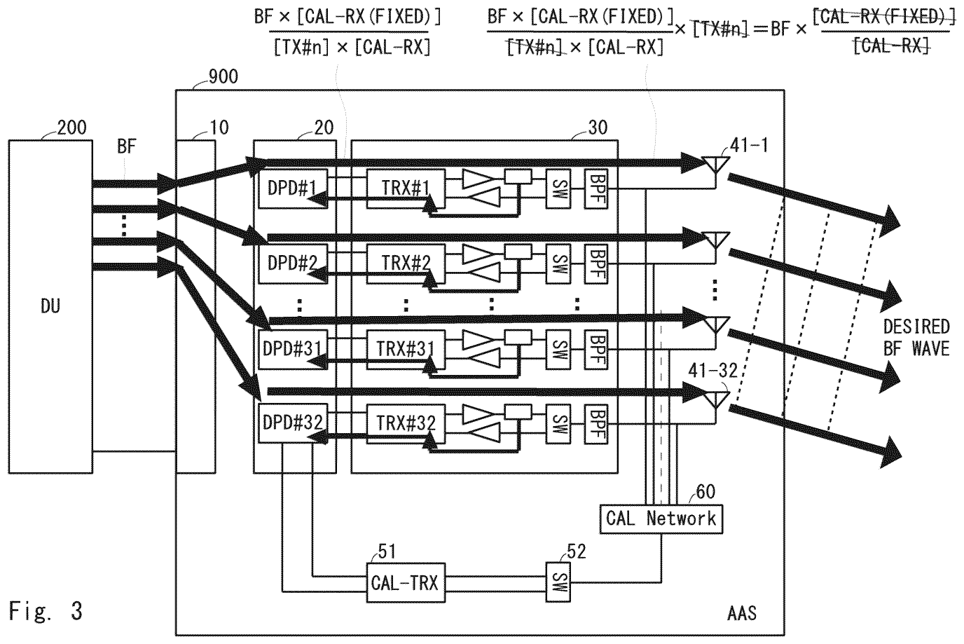

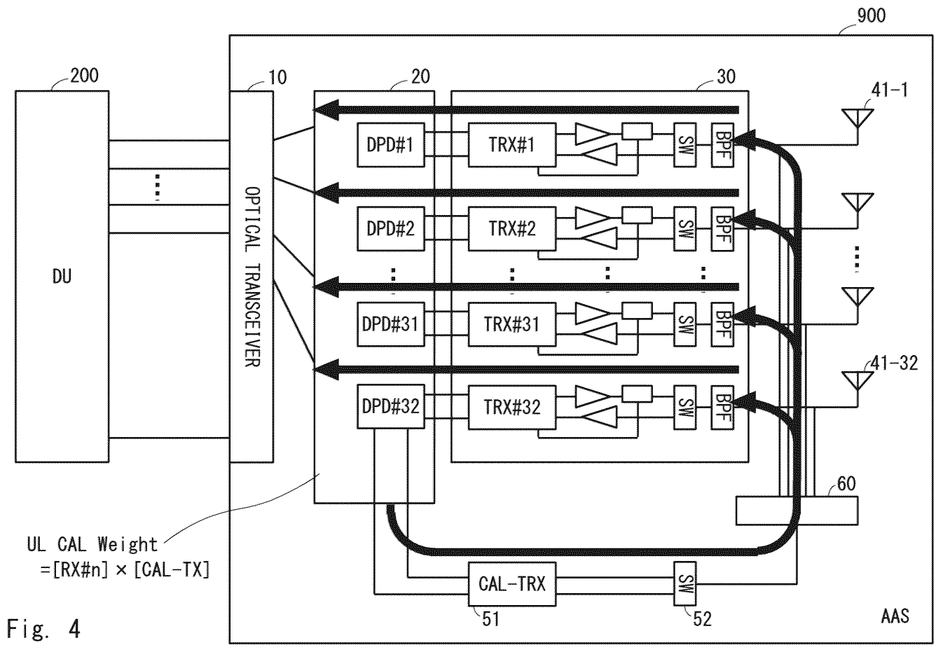

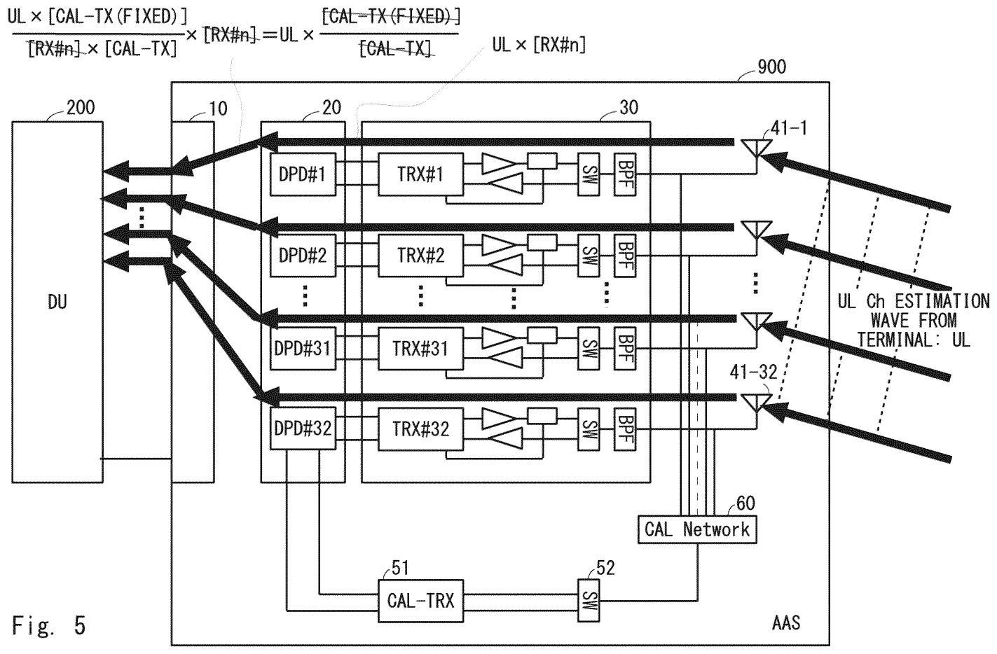

### EXAMPLE EMBODIMENT

Example embodiments of the present disclosure are described below with reference to the drawings. Note that the following description and the drawings are appropriately omitted and simplified for clarity of description. Further, in the following drawings, the same elements are denoted by the same reference symbols, and repetitive description thereof is omitted as required. Further, specific numerals and the like given below are merely examples for easy understanding of the present disclosure, and are not limited thereto.

### First Example Embodiment

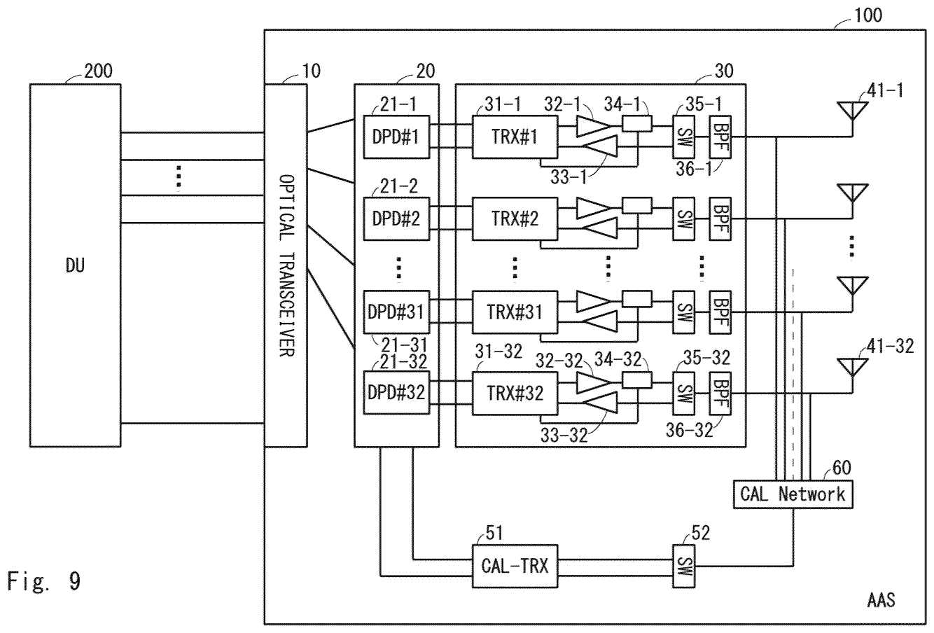

First, with reference to FIG. 9, description is made on a circuit configuration example of an AAS 100 according to the first example embodiment. Note that, in FIG. 9, it is assumed that the AAS 100 is used as a base station. Further, in FIG. 9, description is made while assuming that the AAS 100 includes thirty-two antennas 41-1 to 41-32, which are described later, and the number of antennas included in the AAS 100 is not limited thereto and is only required to be plural.

As illustrated in FIG. 9, the AAS 100 according to the first example embodiment includes a configuration similar to that of the AAS 900 according to the related art, but is different therefrom in a timing at which a UL CAL operation is performed.

Specifically, the AAS 100 according to the first example embodiment performs the UL CAL operation and a DL CAL operation or only performs the UL CAL operation in a time period directly before a DL slot. In the latter case, the AAS 100 may perform the DL CAL operation in a time period after the DL slot (for example, in a time period of GP within a flexible slot of the DL slot) similarly to the AAS 900 according to the related art.

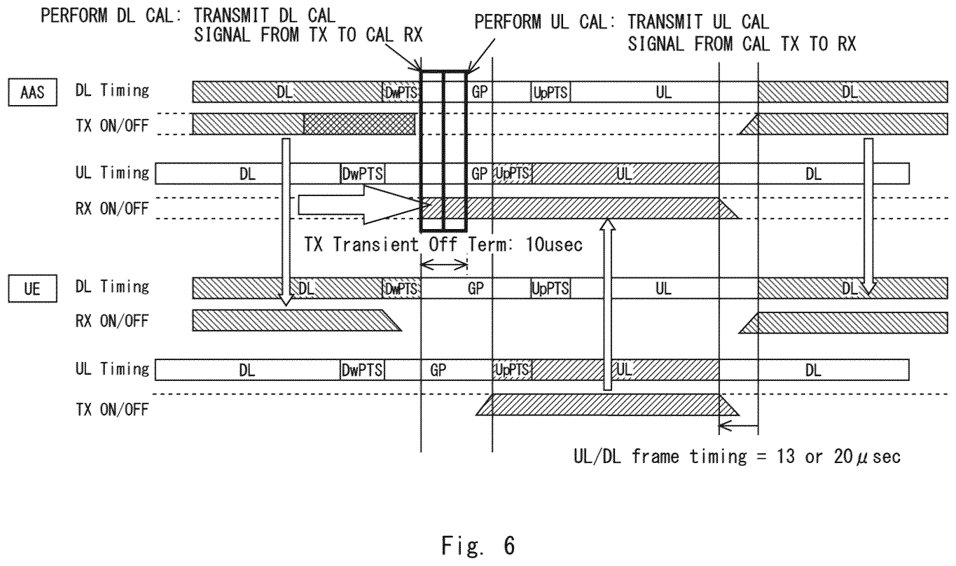

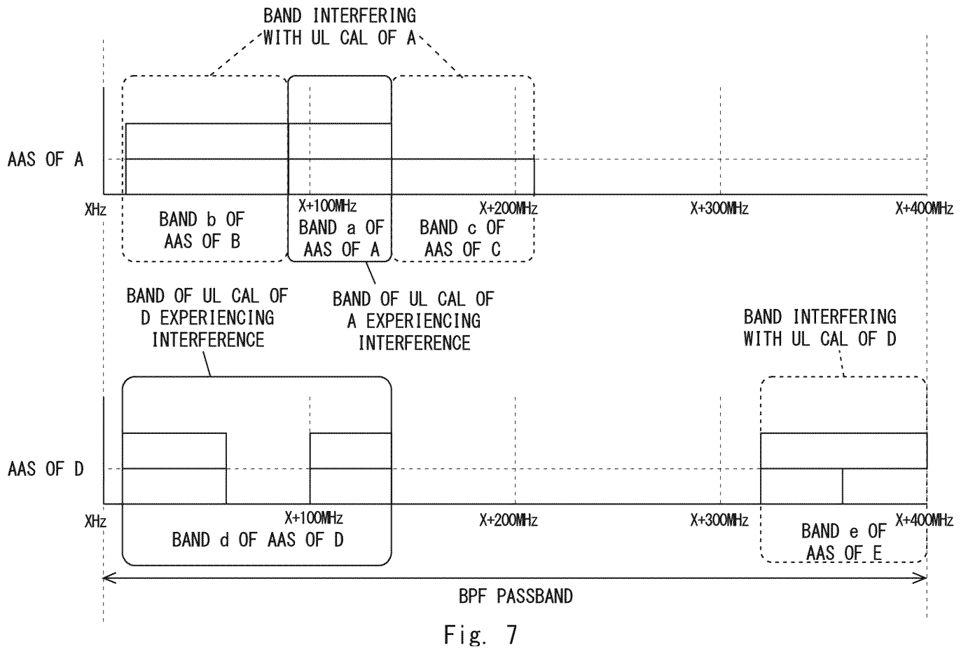

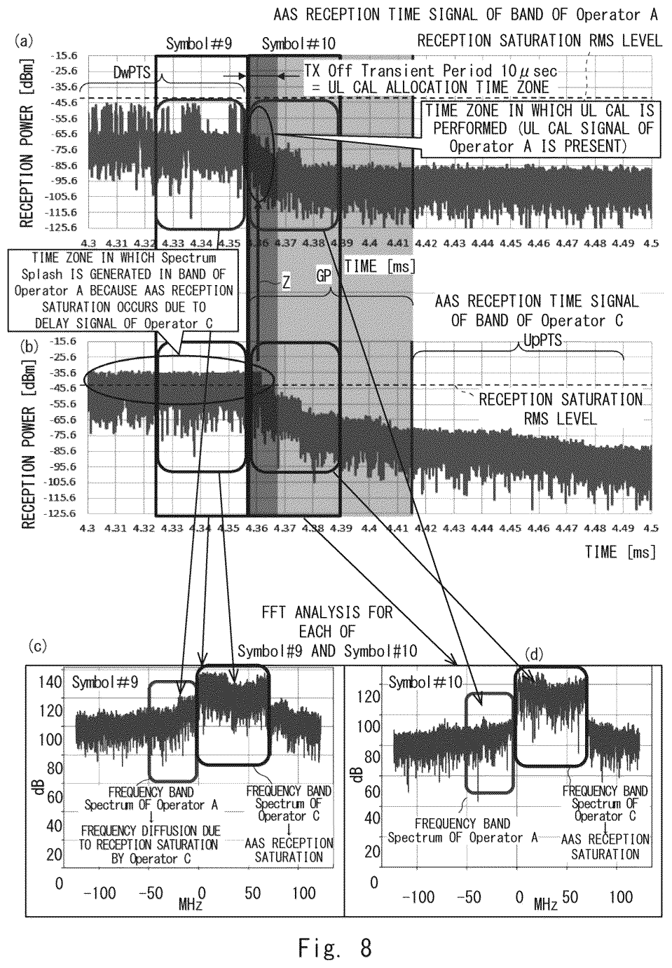

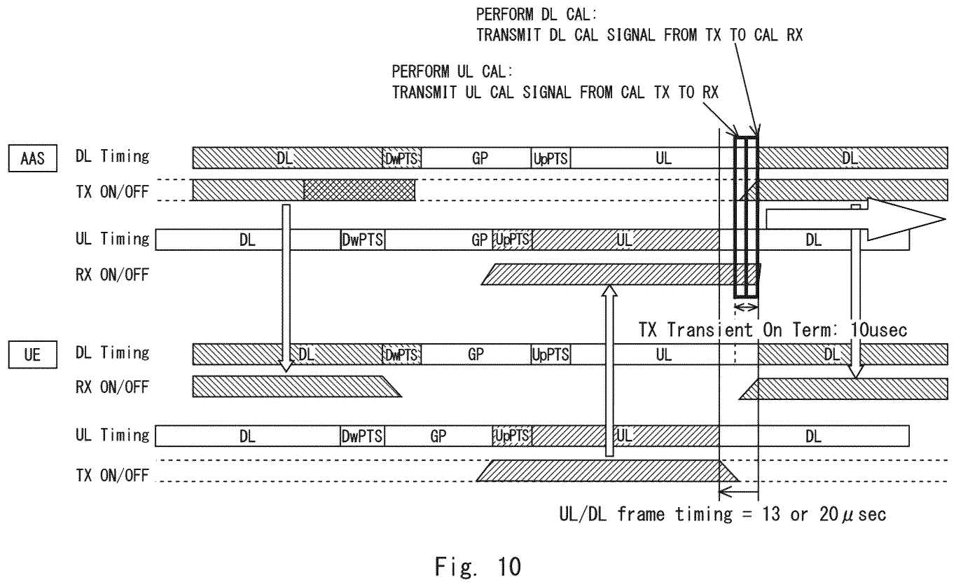

Subsequently, with reference to FIG. 10, description is made on a timing at which the AAS 100 according to the first example embodiment performs the DL CAL operation and the UL CAL operation. In FIG. 10, it is assumed that, in the time period directly before the DL slot, the UL CAL operation and the DL CAL operation are performed. Further, in FIG. 10, the assumption that the AAS 100 performs the TDD operation and the like are similar to the AAS 900 in FIG. 6.

As illustrated in FIG. 10, the AAS 100 according to the first example embodiment performs the UL CAL operation (in other words, an operation of transmitting the UL CAL signal from the CAL-TX 511 to each of the RXs 312-n), and then performs the DL CAL operation (in other words, an operation of transmitting the DL CAL signal from each of the TXs 311-n to the CAL-RX 512) in the time period directly before the DL slot, which is a time period of a Tx on transient period (10 usec) being a time period for switching the TX 311-n from an off state to an on state. Alternatively, the AAS 100 according to the first example embodiment performs the DL CAL (performs the DL Cal collectively or performs the DL CAL a plurality of times for each of the TXs 311-n by allocating the DL CAL signal of each of the TXs 311-n in a frequency-multiplexing manner) or only performs the UL CAL sequentially while using the entire duration of the Tx on transient period (10 usec) for each frame. Alternatively, consideration is given on a case in which the AAS 100 according to the first example embodiment performs the UL CAL operation by exceeding the Tx on transient period ahead up to a UL/DL frame timing (approximate 13 μsec or 20 μsec) (UL/DL frame timing-Tx on transient period) or beyond in some cases.

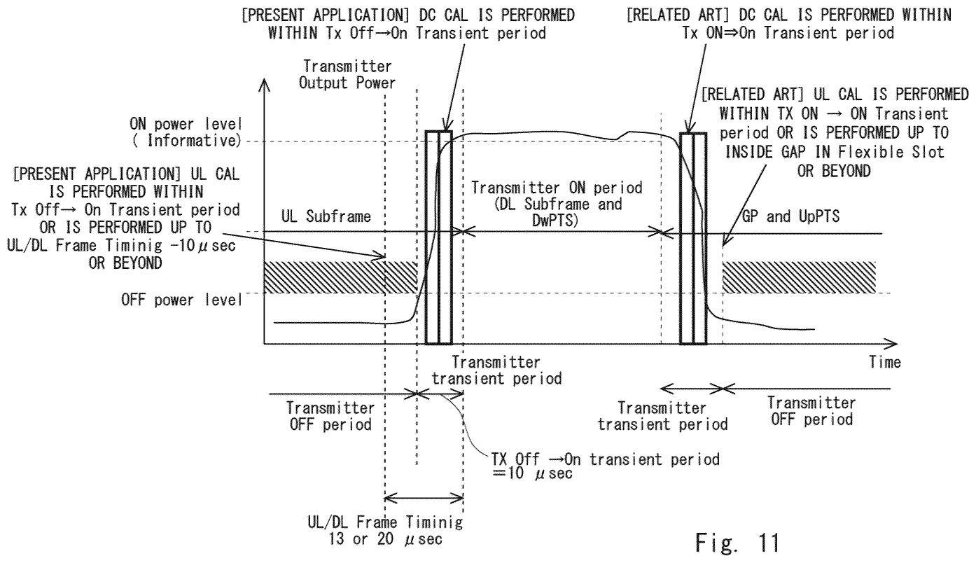

Subsequently, with reference to FIG. 11, description is made on a timing at which the AAS 100 according to the first example embodiment performs the DL CAL operation and the UL CAL operation while the timing is compared with the timing at which the AAS 900 according to the related art performs the DL CAL operation and the UL CAL operation. FIG. 11 illustrates a power level of the TX 311-n at each of the DL timing and UL timing. In FIG. 11, the horizontal axis indicates time, and the vertical axis indicates a power level.

As illustrated in FIG. 11, the AAS 900 according to the related art performs the UL CAL operation in the time period of GP within the flexible slot after the DL slot, that is, the time period of the Tx off transient period. Alternatively, the AAS 900 according to the related art performs the UL CAL operation by exceeding the Tx off transient period up to the GP or beyond in an overflowing manner.

In contrast, the AAS 100 according to the first example embodiment performs the UL CAL operation in the time period directly before the DL slot, that is, the time period of the Tx on transient period. Alternatively, the AAS 100 according to the first example embodiment performs the UL CAL operation by exceeding the Tx on transient period ahead up to the UL/DL frame timing or beyond.

Further, the AAS 900 according to the related art performs the DL CAL operation in the time period of GP in the flexible slot after the DL slot, that is, the time period of the Tx off transient period. Further, the AAS 900 according to the related art performs the DL CAL operation before performing the UL CAL operation.

In contrast, the AAS 100 according to the first example embodiment performs the DL CAL operation in the time period directly before the DL slot, that is, the time period of the Tx on transient period. Further, in a first case regarding the DL CAL operation, the AAS 100 according to the first example embodiment allocates the DL CAL signal being output from each of the plurality of TXs 311-n in a frequency multiplexing manner. With this, the frequency of the DL CAL signal being output from each of the TXs 311-n is determined in advance in such a way as to that the frequencies do not overlap with each other even when the DL CAL signal is combined in the CAL network 60. In other words, the frequency allocation of each sub carrier forming the DL CAL signal by OFDM is determined in advance in such a way as to avoid overlapping at each TX. A method of transmitting the DL CAL signals from all the TXs 311-n to the CAL-RX 512 in one DL CAL period is a first DL CAL signal allocation/transmission method. Another DL CAL signal allocation/transmission method is a method of performing transmission and reception of the DL CAL signal for each frame at one TX 311-n at a time. In other words, a method of sequentially time-division multiplexing the DL CAL signals with frequency overlaps or the DL CAL signals with completely common frequency allocations from each of the TXs 311-n and sequentially transmitting/receiving the DL CAL signals while switching the TX 311-n being a DL CAL target is a second DL CAL signal allocation/transmission method.

Alternatively, in another mode, similarly to the related art, the DL CAL operation may be performed in the Tx off transient period of 10 μsec after the DL slot, and only the UL CAL operation may be performed during the Tx on transient period 10 usec in the leading part of the DL slot. The level of the DL CAL signal can be amplified to a maximum rated power level, and hence the SINR of the DL CAL signal is not affected at all even when the DL delay wave from the adjacent operator base station with an adjacent frequency band is generated. Thus, the DL CAL operation can be performed in the Tx off transient period of 10 μsec after the DL slot.

In this manner, the AAS 100 according to the first example embodiment performs the UL CAL operation in the time period directly before the DL slot. With this, even when an arrival time of the DL delay emission signal from an AAS of another operator to the DL delay emission signal is delayed, the arrival time is shifted to a later time than a time zone in which the UL CAL operation (an operation of transmitting the UL CAL signal from the CAL-TX 511 to each of the RXs 312-n) is performed. Thus, the UL CAL signal can be prevented from being interfered with by the DL delay emission signal from the AAS of the other operator. Thus, regardless of arrival of the DL delay emission signal from the AAS of the other operator, the UL CAL can be performed, and the UL CAL accuracy can be secured.

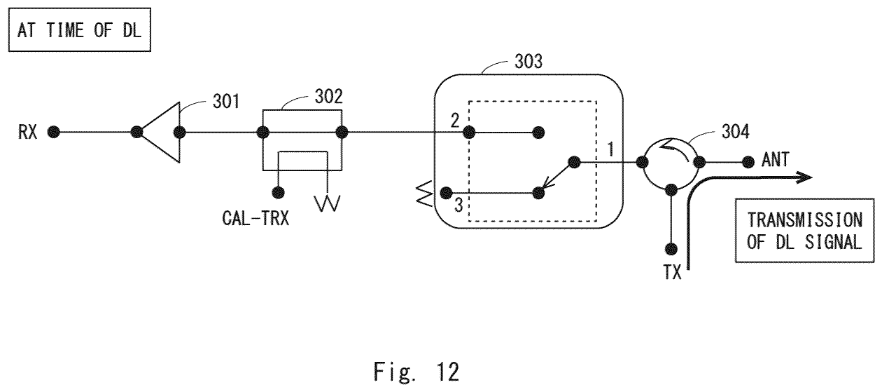

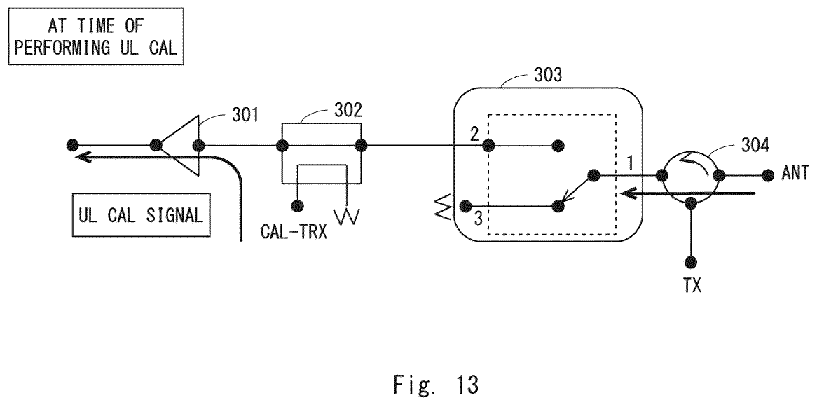

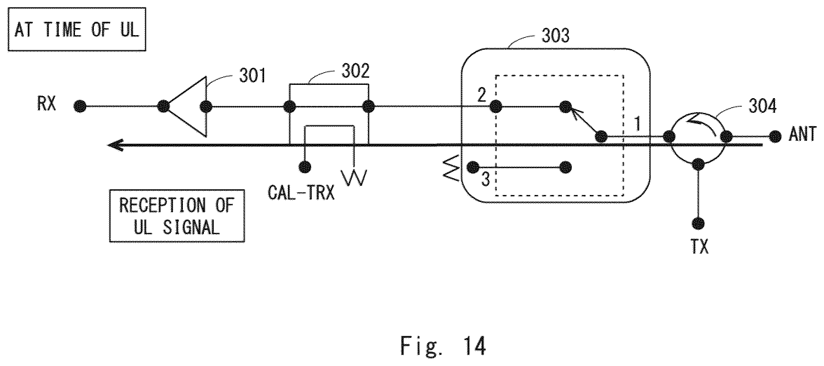

Subsequently, with reference to FIG. 12 to FIG. 14, description is made on advantageous effects as compared to an AAS (hereinafter, referred to as an AAS 901) described in Japanese Unexamined Patent Application Publication No. 2019-216366. FIG. 12 to FIG. 14 illustrate circuit configurations of a reception system circuit in an FE unit in the AAS 901. Further, FIG. 12 illustrates a control method of a reception system circuit when the DL operation is performed, FIG. 13 illustrates a control method of the reception system circuit when the UL CAL operation is performed, and FIG. 14 illustrates a control method of the reception system circuit when the UL operation is performed.

As illustrated in FIG. 12 to FIG. 14, the reception system circuit in an FE unit of the AAS 901 includes a low noise amplifier (LNA) 301 being a reception amplifier, a coupler 302, a SW 303, and a circulator 304.

As illustrated in FIG. 12, in a case in which the DL operation is performed, when the SW 303 between the coupler 302 and an antenna (ANT) is connected to a terminator, the AAS 901 transmits the DL signal from a transmitter (TX) via the antenna (ANT).

Further, as illustrated in FIG. 14, in a case in which the UL operation is performed, when the SW 303 is connected to the coupler 302, the AAS 901 receives the UL signal from the transmitter (TX) via the antenna (ANT).

Further, as illustrated in FIG. 13, when the UL CAL operation is performed, the AAS 901 connects the SW 303 to the terminator similarly to a case in which the DL operation is performed. With this, there can be exerted an effect of attenuating the reception level of the DL delay emission signal from the AAS of the other operator by approximately −30 dB using the isolation of the SW 303. However, during the UL CAL operation, an input end of the LNA 301 is in an open state. Thus, the multipath reflection of the UL CAL signal from the calibration transceiver (CAL-TRX) causes ripple in the amplitude and phase of the UL CAL signal across a wide frequency range. As a result, the alignment accuracy of aligning the amplitude and phase characteristics between the plurality of receivers (RXs) is degraded after the UL CAL operation.

In contrast, in the AAS 100 according to the first example embodiment, the UL CAL signal can be prevented from being interfered with by the DL delay emission signal from the AAS of the other operator. Thus, even when the circuit configuration illustrated in FIG. 12 to FIG. 14 is adopted as the reception system circuit in the FE unit 30, the AAS 100 can perform the UL CAL operation while connecting the SW 303 to the coupler 302. With this, even in a case in which the input end of the LNA 301 is not in an open state, and a real space outside of the antenna, when no foreign object that may cause shading, blocking, or reflection exists in the vicinity of the external environment around the antenna, a return loss anticipated from the external environment around the antenna is expected to be satisfactory similarly to a case of termination. Thus, the alignment accuracy of the amplitude and phase characteristics between the plurality of receivers (RXs) after the UL CAL operation is improved across a wide frequency range, and the UL CAL accuracy can be secured.

Further, in the AAS 100 according to the first example embodiment, even when the input end of the reception amplifier 33-n is directly connected to the antenna 41-n to perform the UL CAL operation, the UL CAL signal can be prevented from being interfered with by the DL delay emission signal from the AAS of the other operator. Thus, an injection point of a UL CAL signal and a DL CAL signal can be allocated in a commonly shared manner between the antenna 41-n and the BPF 36-n.

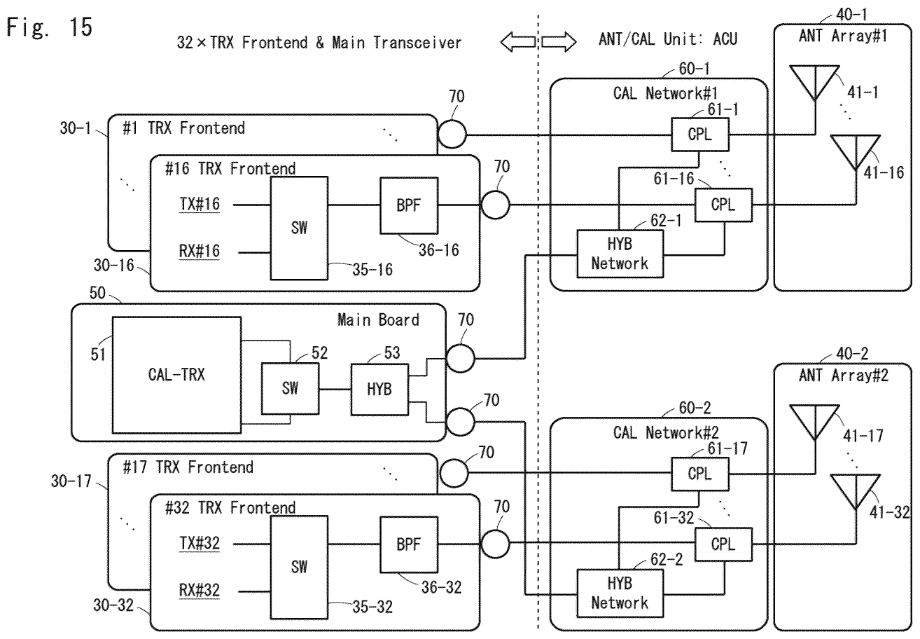

With reference to FIG. 15, description is made on a circuit configuration example when an injection point of the UL CAL signal and the DL CAL signal is allocated in a commonly shared manner between the antenna 41-n and the BPF 36-n in the AAS 100 according to the first example embodiment. In FIG. 15, the optical transceiver 10 and the BB unit 20 that are illustrated in FIG. 9 are omitted in illustration.

As illustrated in FIG. 15, the AAS 100 according to the first example embodiment includes thirty-two transceiver-frontend (TRX-frontend) units 30-n, a main board 50, calibration networks (CAL networks) 60-1 and 60-2, and antenna arrays 40-1 and 40-2.

The transceiver-frontend (TRX-frontend) unit 30-n is acquired by forming the TX 311-n, the TX 311-n, the SW 35-n, the BPF 36-n, the transmission amplifier 32-n, the reception amplifier 33-n, and the coupler 34-n into one unit. However, in FIG. 15, the transmission amplifier 32-n, the reception amplifier 33-n, and the coupler 34-n are omitted in illustration. A combination of the thirty-two TRX-frontend units 30-n is associated with the FE unit 30 illustrated in FIG. 9.

The main board 50 is acquired by forming the CAL-TRX 51, the SW 52, and a hybrid (HYB) 53 into one unit.

The CAL network 60-1 is acquired by forming sixteen couplers (CPLs) 61-1 to 61-16 and a hybrid network (HYB network) 62-1 into one unit. Further, the CAL network 60-2 is acquired by forming sixteen couplers 61-17 to 61-32 and a HYB network 62-2 into one unit. A combination of the CAL networks 60-1 and 60-2 is associated with the CAL network 60 illustrated in FIG. 9.

The antenna array 40-1 is acquired by forming sixteen antennas 41-1 to 41-16 into one unit. Further, the antenna array 40-2 is acquired by forming sixteen antennas 41-17 to 41-32 into one unit.

The sixteen TRX-frontend units 30-1 to 30-16 are connected to the CAL network 60-1 via a connector 70. Further, the sixteen TRX-frontend units 30-17 to 30-32 are connected to the CAL network 60-2 via the connector 70. Further, the main board 50 is connected to each of the CAL networks 60-1 and 60-2 via the connector 70.

In this manner, the circuit elements can be formed into a unit, and hence the circuit configuration of the AAS 100 according to the first example embodiment can be simplified. Further, the units can be connected via the connector 70, and hence connection between the units in the AAS 100 according to the first example embodiment can be simplified.

As described above, the AAS 100 according to the first example embodiment performs the UL CAL operation in the time period directly before the DL slot. With this, even when an arrival time of the DL delay emission signal from an AAS of another operator to the DL delay emission signal is delayed, the arrival time is shifted to a later time than a time zone in which the UL CAL operation (an operation of transmitting the UL CAL signal from the CAL-TX 511 to each of the RXs 312-n) is performed. Thus, the UL CAL signal can be prevented from being interfered with by the DL delay emission signal from the AAS of the other operator. Thus, regardless of arrival of the DL delay emission signal from the AAS of the other operator, the UL CAL can be performed, and the UL CAL accuracy can be secured.

### Second Example Embodiment

A second example embodiment is an example embodiment schematically illustrating the above-mentioned first example embodiment.

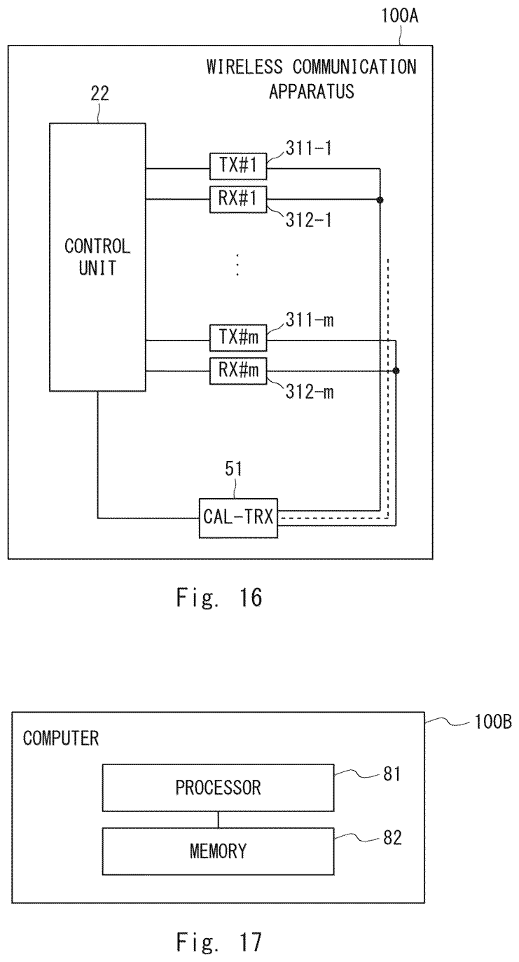

First, with reference to FIG. 16, a circuit configuration example of a wireless communication apparatus 100A according to the second example embodiment is described. Note that, in FIG. 16, it is assumed that the wireless communication apparatus 100A is used as a base station.

As illustrated in FIG. 16, the wireless communication apparatus 100A according to the second example embodiment includes a control unit 22, m (m is an integer equal to or greater than 2) transmitters (TXs) 311-1 to 311-m, m receivers (RXs) 312-1 to 312-m, and a calibration transceiver (CAL-TRX) 51.

Note that, in the following description, when description is made without distinguishing the TXs 311-1 to 311-m from one another, the TXs are referred to as TXs 311-n (n=1, . . . , m) as appropriate. Similarly, the RXs 312-1 to 312-m are referred to as RXs 312-n as appropriate.

The control unit 22 is associated with the BB unit 20 of the above-mentioned first example embodiment.

The m TXs 311-n and the m RXs 312-n are provided in association with m antennas (omitted in illustration).

The control unit 22 controls an uplink calibration (UL CAL) operation being an operation of transmitting an uplink calibration (UL CAL) signal from the CAL-TRX 51 to each of the m RXs 312-n.

Herein, the wireless communication apparatus 100A performs a time division duplex (TDD) operation.

Further, the control unit 22 performs control in such a way as to perform the UL CAL operation in a predetermined time period before a downlink slot (DL slot) in which each of the m TXs 311-n transmits a downlink (DL) signal.

With this, even when an arrival time a DL delay emission signal from the wireless communication apparatus of another operator to the wireless communication apparatus 100A is delayed, the arrival time is shifted to a later time than a time zone in which the UL CAL operation (an operation of transmitting the UL CAL signal from the CAL-TRX 51 to each of the RXs 312-n) is performed. Thus, the UL CAL signal can be prevented from being interfered with by the DL delay emission signal from the wireless communication apparatus of the other operator. Thus, regardless of arrival of the DL delay emission signal from the wireless communication apparatus of the other operator, the UL CAL can be performed, and the UL CAL accuracy can be secured.

Note that the control unit 22 may control a downlink calibration (DL CAL) operation being an operation of transmitting a downlink calibration (DL CAL) signal from each of the m TXs 311-n to the CAL-TRX 51.

Further, the control unit 22 may perform control in such a way as to perform the DL CAL operation in the predetermined time period before the DL slot. In this state, the control unit 22 may perform the predetermined time period before the DL slot and then perform the DL CAL operation in the predetermined time period before the DL slot.

Alternatively, the control unit 22 may perform control in such a way as to perform the DL CAL operation or the UL CAL operation sequentially for each frame in the predetermined time period before the DL slot.

Alternatively, the control unit 22 may perform control in such a way as to perform only the UL CAL operation for each frame in the predetermined time period before the DL slot and perform the DL CAL operation in a second predetermined time period after the DL slot.

Further, the predetermined time period before the DL slot may be set within a time width of a period for switching each of the m TXs 311-n from an off state to an on state (for example, the Tx on transient period). Alternatively, the predetermined time period before the DL slot may be set within a time width of an uplink/downlink frame timing (UL/DL frame timing).

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

For example, some of the functions of the wireless communication apparatus (including the AAS) according to the present disclosure can be achieved by causing a processor such as a central processing unit (CPU) to execute a program.

With reference to FIG. 17, description is made on a hardware configuration example of a computer 100B that achieves some of the functions of the wireless communication apparatus according to the present disclosure.

As illustrated in FIG. 17, the computer 100B includes a processor 81 and a memory 82.

For example, the processor 81 may be a micro processor, a CPU, or a micro processing unit (MPU). The processor 81 may include a plurality of processors.

The memory 82 is configured by a combination of a volatile memory and a non-volatile memory. The memory 82 may include a storage arranged away from the processor 81. In this case, the processor 81 may access to the memory 82 via an input (I)/output (O) interface omitted in illustration.

The memory 82 stores a program. The program includes a command group (or a software code) for causing the computer 100B to execute some of the functions of the AAS 100 or the wireless communication apparatus 100A according to the first or second embodiment described above when the program is read by the computer 100B. The processor 81 may achieve the above-mentioned constituent elements of the AAS 100 or the wireless communication apparatus 100A by reading and executing the program stored in the memory 82. Further, the above-mentioned constituent element including the storage function of the AAS 100 or the wireless communication apparatus 100A may be achieved by the memory 82.

Further, the above-mentioned program may be stored in a non-transitory computer readable medium or a solid storage medium. Examples of the computer readable medium or the solid storage medium include, but are not limited to, a random-access memory (RAM), a read-only memory (ROM), a flash memory, a solid-state drive (SSD), or other memory techniques, a CD-ROM, a digital versatile disc (DVD), a Blu-ray (registered trademark) disc, or other optical disc storages, and a magnetic cassette, a magnetic tape, a magnetic disc storage, or other magnetic storage devices. The program may be transmitted via a non-transitory computer readable medium or a communication medium. Examples of the non-transitory computer readable medium or the communication medium include, but are not limited to, a propagation signal in an electric, optical, acoustic, or other formats.

The first and second embodiments can be combined as desirable by one of ordinary skill in the art.

The whole or part of the exemplary embodiments disclosed above can be described as, but not limited to, the following supplementary notes.

### (Supplementary Note 1)

A wireless communication apparatus comprising:
a plurality of transmitters;
a plurality of receivers;
a calibration transceiver; and
a controller configured to control an uplink calibration operation of transmitting an uplink calibration signal from the calibration transceiver to each of the plurality of receivers, wherein
the wireless communication apparatus performs a time division duplex (TDD) operation, and
the controller performs control in such a way as to perform the uplink calibration operation in a predetermined time period before a downlink slot in which each of the plurality of transmitters transmits a downlink signal.

### (Supplementary Note 2)

The wireless communication apparatus according to supplementary note 1, wherein
the controller controls a downlink calibration operation of transmitting a downlink calibration signal from each of the plurality of transmitters to the calibration transceiver, and
the controller performs control in such a way as to perform the downlink calibration operation in the predetermined time period before the downlink slot.

### (Supplementary Note 3)

The wireless communication apparatus according to supplementary note 2, wherein
the controller performs control in such a way as to perform the uplink calibration operation and then perform the downlink calibration operation in the predetermined time period before the downlink slot.

### (Supplementary Note 4)

The wireless communication apparatus according to supplementary note 2, wherein
the controller performs control in such a way as to perform the downlink calibration operation or the uplink calibration operation sequentially for each frame in the predetermined time period before the downlink slot.

### (Supplementary Note 5)

The wireless communication apparatus according to supplementary note 2, wherein
the controller performs control in such a way as to perform only the uplink calibration operation for each frame in the predetermined time period before the downlink slot and perform the downlink calibration operation in a second predetermined time period after the downlink slot.

### (Supplementary Note 6)

The wireless communication apparatus according to any one of supplementary notes 1 to 5, wherein
the predetermined time period before the downlink slot is set within a time width of a period for switching each of the plurality of transmitters from an off state to an on state.

### (Supplementary Note 7)

The wireless communication apparatus according to any one of supplementary notes 1 to 5, wherein
the predetermined time period before the downlink slot is set within a time width of an uplink/downlink frame timing.

### (Supplementary Note 8)

A wireless communication method being performed by a wireless communication apparatus including a plurality of transmitters, a plurality of receivers, and a calibration transceiver, and being configured to perform a time division duplex (TDD) operation, the wireless communication method comprising:
a control step of controlling an uplink calibration operation of transmitting an uplink calibration signal from the calibration transceiver to each of the plurality of receivers, wherein,
in the control step, control is performed in such a way as to perform the uplink calibration operation in a predetermined time period before a downlink slot in which each of the plurality of transmitters transmits a downlink signal.

What is claimed is:

1. A wireless communication apparatus comprising:
a plurality of transmitters;
a plurality of receivers;
a calibration transceiver; and
a controller configured to control an uplink calibration operation of transmitting an uplink calibration signal from the calibration transceiver to each of the plurality of receivers, wherein
the wireless communication apparatus performs a time division duplex (TDD) operation, and
the controller performs control in such a way as to perform the uplink calibration operation in a predetermined time period before a downlink slot in which each of the plurality of transmitters transmits a downlink signal.

2. The wireless communication apparatus according to claim 1, wherein
the controller controls a downlink calibration operation of transmitting a downlink calibration signal from each of the plurality of transmitters to the calibration transceiver, and
the controller performs control in such a way as to perform the downlink calibration operation in the predetermined time period before the downlink slot.

3. The wireless communication apparatus according to claim 2, wherein
the controller performs control in such a way as to perform the uplink calibration operation and then perform the downlink calibration operation in the predetermined time period before the downlink slot.

4. The wireless communication apparatus according to claim 2, wherein
the controller performs control in such a way as to perform the downlink calibration operation or the uplink calibration operation sequentially for each frame in the predetermined time period before the downlink slot.

5. The wireless communication apparatus according to claim 2, wherein
the controller performs control in such a way as to perform only the uplink calibration operation for each frame in the predetermined time period before the downlink slot and perform the downlink calibration operation in a second predetermined time period after the downlink slot.

6. The wireless communication apparatus according to claim 1, wherein
the predetermined time period before the downlink slot is set within a time width of a period for switching each of the plurality of transmitters from an off state to an on state.

7. The wireless communication apparatus according to claim 1, wherein
the predetermined time period before the downlink slot is set within a time width of an uplink/downlink frame timing.

8. A wireless communication method being performed by a wireless communication apparatus including a plurality of transmitters, a plurality of receivers, and a calibration transceiver, and being configured to perform a time division duplex (TDD) operation, the wireless communication method comprising:
a control step of controlling an uplink calibration operation of transmitting an uplink calibration signal from the calibration transceiver to each of the plurality of receivers, wherein,
in the control step, control is performed in such a way as to perform the uplink calibration operation in a predetermined time period before a downlink slot in which each of the plurality of transmitters transmits a downlink signal.
